(19) United States
(12) Patent Application Publication
(10) Pub. No.: US 2026/0213194 A1
(43) Pub. Date: Jul. 23, 2026

(54) NEGATIVE ELECTRODE ACTIVE MATERIAL LAYER AND BATTERY

(71) Applicant: TOYOTA JIDOSHA KABUSHIKI KAISHA, Toyota-shi (JP)

(72) Inventor: Satoshi MIZUTANI, Okazaki-shi (JP)

(73) Assignee: TOYOTA JIDOSHA KABUSHIKI KAISHA, Toyota-shi (JP)

(21) Appl. No.: 19/398,622

(22) Filed: Nov. 24, 2025

(30) Foreign Application Priority Data
Jan. 22, 2025 (JP) 2025-009247

(51) Int. Cl. H01M 4/583; H01M 4/02; H01M 4/38; H01M 4/62

(52) U.S. Cl. CPC H01M 4/583; H01M 4/387; H01M 4/623; H01M 2004/027

(57) ABSTRACT

The present disclosure provides a negative electrode active material layer that can increase the initial charge-discharge efficiency of a battery, and a battery comprising the negative electrode active material layer. The negative electrode active material layer 120 of the disclosure comprises negative electrode active material composite particles 10, and a particulate binder 20 which binds together the negative electrode active material composite particles. The negative electrode active material composite particles of the disclosure comprise a carbon material 11 and a tin alloy 12 supported in the carbon material, and have pores 14. The battery 100 of the disclosure has a negative electrode active material layer 120 of the disclosure.

### FIELD

The present disclosure relates to a negative electrode active material layer and a battery.

### BACKGROUND

PTL 1 discloses a negative electrode material having a reaction phase comprising an element (such as tin) capable of producing an intermetallic compound with lithium, and a carbon material. PTL 1 discloses that when the reaction phase contains carbon, the element that is capable of forming an intermetallic compound with lithium becomes low crystalline or amorphous, thereby allowing smooth occlusion and detachment of lithium and ensuring satisfactory contact properties and reactivity for electrolytes.

PTL 2 discloses a negative electrode comprising a particulate negative electrode active material, and a particulate binder comprising at least one from among vinylidene fluoride-containing copolymers and polyvinylidene fluoride. PTL 2 discloses that since the binder is particulate and therefore does not cover the negative electrode active material, this inhibits electrode reaction by the binder.

### CITATION LIST

### Patent Literature

[PTL 1] International Patent Publication No. WO2004/100291
[PTL 2] Japanese Unexamined Patent Publication No. 2004-146253

### SUMMARY

### Technical Problem

Negative electrode active material layers comprising a carbon material and a tin alloy, such as disclosed in PTL 1, are in need of improvement from the viewpoint of improving the initial charge-discharge efficiency of batteries.

It is an object of the present disclosure to provide a negative electrode active material layer that can increase the initial charge-discharge efficiency of a battery, and a battery comprising the negative electrode active material layer.

### Solution to Problem

The present inventors have found that the aforementioned object can be achieved by the following means.

### <Aspect 1>

A negative electrode active material layer comprising negative electrode active material composite particles and a particulate binder which binds together the negative electrode active material composite particles,
wherein the negative electrode active material composite particles:
comprise a carbon material and a tin alloy supported in the carbon material, and have pores.

### <Aspect 2>

The negative electrode active material layer according to aspect 1, wherein the binder is polyvinylidene fluoride.

### <Aspect 3>

The negative electrode active material layer according to aspect 1 or 2, wherein the binder content is 1 mass % to 10 mass %.

### <Aspect 4>

The negative electrode active material layer according to any one of aspects 1 to 3, which further comprises hard carbon.

### <Aspect 5>

A battery having a negative electrode active material layer according to any one of aspects 1 to 4.

### Advantageous Effects of Invention

The present disclosure can provide a negative electrode active material layer that can improve the initial charge-discharge efficiency of a battery, as well as a battery comprising the negative electrode active material layer.

### BRIEF DESCRIPTION OF DRAWINGS

FIG. 1 is a simplified cross-sectional view showing an example of a negative electrode active material layer of the disclosure.

FIG. 2A shows a schematic diagram of the carbon-tin alloy complex.

FIG. 2B shows a schematic diagram of the negative electrode active material composite particle precursor.

FIG. 2C shows a schematic diagram of the negative electrode active material composite particles.

FIG. 3 is a simplified cross-sectional view showing an example of a battery of the disclosure.

### DESCRIPTION OF EMBODIMENTS

An embodiment of the disclosure will now be described in detail. The disclosure is not limited to the embodiment described below, however, and various modifications may be implemented which do not depart from the gist thereof.

### <Negative Electrode Active Material Layer>

The negative electrode active material layer of the disclosure comprises negative electrode active material composite particles, and a particulate binder which binds together the negative electrode active material composite particles. The negative electrode active material composite particles of the disclosure comprise a carbon material and a tin alloy supported in the carbon material, and have pores.

The present inventors have found, unexpectedly, that the initial charge-discharge efficiency of a battery can be improved if the negative electrode active material layer comprises a particulate binder that binds together multiple specified negative electrode active material composite particles, and the negative electrode active material composite particles have pores.

The present inventors considered that one reason for insufficient initial charge-discharge efficiency of a battery with a negative electrode active material layer comprising a carbon material and a tin alloy, is that the binder and the carrier ion such as sodium ion undergo reaction, thereby increasing irreversible capacity.

In this regard, it is believed that reducing the contact area between the binder and the carrier ion in the negative electrode active material layer, i.e. using a particulate binder, for example, can inhibit reaction between the binder and the carrier ion. However, when a particulate binder is used in a negative electrode active material layer comprising a negative electrode active material that undergoes expansion and contraction during charge-discharge of a battery, such as a tin alloy, the binder may fail to properly function due to expansion and contraction of the tin alloy.

In contrast, in the negative electrode active material layer of the disclosure, tin alloy as the negative electrode active material is supported in the carbon material to form negative electrode active material composite particles, with the negative electrode active material composite particles having pores. In this type of negative electrode active material composite particles, the pores can help reduce the effect of expansion and contraction of the tin alloy, allowing a satisfactory negative electrode active material layer to be formed even with a particulate binder. Therefore, with the negative electrode active material layer of the disclosure, it is thought that the inhibited increase in irreversible capacity caused by reaction between the binder and the carrier ion can improve the initial charge-discharge efficiency of the battery.

The elements composing the negative electrode active material layer of the disclosure will now be described.

### <Negative Electrode Active Material Composite Particles>

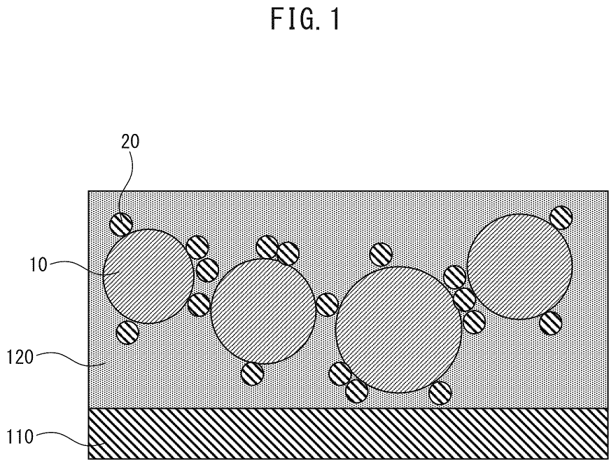

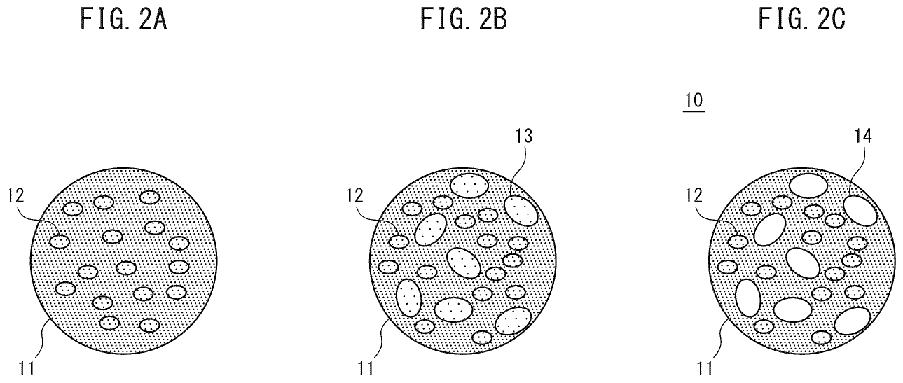

As shown in FIG. 1, the negative electrode active material layer of the disclosure comprises negative electrode active material composite particles 10. While not shown in FIG. 1, the negative electrode active material composite particles 10 comprise a carbon material 11 and a tin alloy 12, and have pores 14, as shown in FIGS. 2A to 2C.

While the negative electrode active material composite particles 10 are shown as spherical shapes in FIG. 1, the shapes of the negative electrode active material composite particles 10 are not limited to such shapes. The sizes are also not particularly restricted. The negative electrode active material composite particles may be particulate or powdered, for example.

The content of the negative electrode active material composite particles is not particularly restricted and may be set as appropriate in consideration of the desired battery capacity.

### (Carbon Material)

The negative electrode active material composite particles comprise a carbon material. The carbon material functions as a parent material which supports the tin alloy inside it. If the negative electrode active material composite particles comprise a carbon material, it is possible to lower the crystallinity of the tin alloy, thereby allowing the tin alloy to smoothly occlude and detach carrier ions. The carbon material may be amorphous, in which case the carbon material does not need to contribute to charge-discharge of the battery.

The starting material for the carbon material is not particularly restricted, and examples include non-graphitizable carbon, graphitizable carbon, graphite, pyrolytic carbon, coke, glassy carbon, fired organic polymer compounds, active carbon and carbon black, as well as combinations of the foregoing.

The carbon material content is not particularly restricted and may be 10 mass % or higher, 11 mass % or higher, 12 mass % or higher, 13 mass % or higher, 14 mass % or higher or 15 mass % or higher, and 30 mass % or lower, 28 mass % or lower, 26 mass % or lower, 24 mass % or lower, 22 mass % or lower or 20 mass % or lower, for example.

The content of the carbon material in the negative electrode active material composite particles can be quantified by a combustion method using a carbon/sulfur analyzer (CS meter), for example.

### (Tin Alloy)

The negative electrode active material composite particles comprise a tin alloy supported in the carbon material. The tin alloy has the function of storing and desorbing carrier ions such as sodium ion, and thus contributes to charge-discharge of the battery. The tin alloy expands and contracts during charge-discharge of the battery.

The tin alloy may be an alloy containing tin and at least one metal selected from among cobalt, iron, copper and nickel.

The tin alloy content and composition are not particularly restricted. For example, the tin alloy can be quantified by energy dispersive fluorescent X-ray spectroscopy (EDX) and high-frequency inductively coupled plasma (ICP) emission spectroscopy.

The half-width of the tin alloy in the XRD spectrum is not particularly restricted, and may be 0.3° or greater, 0.5° or greater, 0.7° or greater, 1.0° or greater, 1.5° or greater, 2.0° or greater or 3.0° or greater, and 10.0° or less, 8.0° or less, 6.0° or less or 5.0° or less, for example. The XRD spectrum may include, for example, a diffraction peak obtained by X-ray diffraction using CuKα rays as the specific X-rays, with the sweep rate set to 1°/min. The half-width of the tin alloy in the XRD spectrum can be evaluated as the half-width of the peak near 20=45°. The half-width of the tin alloy in the XRD spectrum can also be evaluated in the discharged state, i.e. in a state without insertion of a carrier ion.

### (Pores)

The negative electrode active material composite particles have pores. This can alleviate expansion and contraction of the tin alloy that occurs with charge-discharge of the battery, so that a satisfactory negative electrode active material layer can be formed even with a particulate binder.

The proportion of the pore volume in the negative electrode active material composite particles is not particularly restricted and may be 1 vol % or greater, 3 vol % or greater, 5 vol % or greater, 8 vol % or greater, 9 vol % or greater or 10 vol % or greater, and 30 vol % or lower, 25 vol % or lower, 20 vol % or lower, 15 vol % or lower, 13 vol % or lower, 12 vol % or lower or 11 vol % or lower, for example.

The mean diameter of the pores is not particularly restricted and may be 0.1 μm or larger or 0.2 μm or larger, and 1.0 μm or smaller, 0.8 μm or smaller, 0.6 μm or smaller or 0.4 μm or smaller, for example.

The volume proportion and mean diameter of the pores can be measured by mercury porosimetry, for example.

### (Metal Silicon, Silicon Oxide and Silicon Carbide)

The negative electrode active material composite particles may further comprise one or more from among metal silicon, silicon oxide and silicon carbide. The metal silicon and/or silicon oxide can be eluted from the negative electrode active material composite particle precursor with an alkaline solution to form pores, as described below. The metal silicon and silicon oxide may therefore be the non-eluted residue remaining after elution with an alkaline solution. The term “silicon oxide” refers particularly to silicon dioxide (SiO₂). The silicon carbide may be one produced from metal silicon.

There are no particular restrictions on the method of detecting the metal silicon, silicon oxide and silicon carbide. Metal silicon can be detected by energy dispersive fluorescent X-ray spectroscopy (EDX) and high-frequency inductively coupled plasma (ICP) emission spectroscopy, for example. Silicon oxide can be detected, for example, by infrared absorption, acid dissolution or ICP-AES. The silicon carbide can be detected by X-ray diffraction (XRD).

There are no particular restrictions on the content of the metal silicon, silicon oxide and silicon carbide.

### <Method for Producing Negative Electrode Active Material Composite Particles>

The negative electrode active material composite particles of the disclosure can be produced, for example, by a method comprising the following steps:
mixing a carbon material, tin, a metal that forms an alloy with tin, and metal silicon and/or silicon oxide by a mechanical alloying method, to obtain a negative electrode active material composite particle precursor, and
contacting the negative electrode active material composite particle precursor with an alkaline solution to elute out the metal silicon and/or silicon oxide, thereby forming pores.

In the step of obtaining the negative electrode active material composite particle precursor by mixing the carbon material, the tin, the metal that forms an alloy with tin and the metal silicon and/or silicon oxide by mechanical alloying, the components may be mixed in any desired order.

Specifically, for example, the metal forming the carbon material, the tin and the metal that forms an alloy with tin may be mixed by mechanical alloying, after which the metal silicon and/or silicon oxide may be further added to the obtained carbon-tin alloy complex and further mixed by mechanical alloying to obtain a negative electrode active material composite particle precursor.

In other words, the negative electrode active material composite particles of the disclosure may be produced by a method comprising the following steps:
(a) the carbon material, the tin and the metal that is to form the alloy with tin are mixed by a mechanical alloying method to obtain a carbon-tin alloy complex;
(b) the carbon-tin alloy complex and the metal silicon and/or silicon oxide are mixed by mechanical alloying to obtain a negative electrode active material composite particle precursor; and
(c) the negative electrode active material composite particle precursor is contacted with an alkaline solution to elute out the metal silicon and/or silicon oxide, thereby forming pores.

The method for producing the negative electrode active material composite particles of the disclosure by the method comprising steps (a) to (c) will now be explained by way of example.

FIG. 2A shows a schematic diagram of the carbon-tin alloy complex obtained in step (a), FIG. 2B shows a schematic diagram of the negative electrode active material composite particle precursor obtained in step (b), and FIG. 2C shows a schematic diagram of the negative electrode active material composite particles 10 obtained in step (c). In FIGS. 2A to 2C, 11 represents a carbon material, 12 represents a tin alloy, 13 represents metal silicon and/or silicon oxide, and 14 represents pores.

The method of the disclosure may also include (a) mixing the carbon material, the metal that forms an alloy with tin, and tin, by a mechanical alloying method to obtain a carbon-tin alloy complex.

The composition of the tin alloy can be adjusted by varying the amounts of the metal and tin used in the method of the disclosure.

The mechanical alloying method may be, for example, a method of treating the starting materials with a ball mill at a specified rotational speed for a predetermined time period, under an inert gas atmosphere. By controlling the rotational speed and treatment time during treatment in this step, for example, it is possible to adjust the half-width of the tin alloy, and the pore volume proportion.

The method of the disclosure may also include a step of (b) mixing a carbon-tin alloy complex with metal silicon and/or silicon oxide by mechanical alloying to obtain a negative electrode active material composite particle precursor.

The mechanical alloying may be carried out as described above in step (a). By controlling the rotational speed and treatment time during treatment in this step, for example, it is possible to adjust the volume proportion and mean diameter of the pores, as well as the contents of the metal silicon, silicon oxide and silicon carbide in the negative electrode active material composite particles.

The method of the disclosure may also include a step of (c) contacting the negative electrode active material composite particle precursor with an alkaline solution to elute out the metal silicon and/or silicon oxide, thereby forming pores.

The method of contacting the negative electrode active material composite particle precursor with the alkaline solution may be a method of immersing the negative electrode active material composite particle precursor in the alkaline solution and stirring the mixture, for example. By controlling the immersion and stirring time in this step it is possible to control the contents of the metal silicon, silicon oxide and silicon carbide in the negative electrode active material composite particles.

Using metal silicon and/or silicon oxide as the component for contact and elution in the alkaline solution in step (c) facilitates production of the negative electrode active material composite particles that further comprise metal silicon, silicon oxide and silicon carbide.

In step (b), another component that elutes out upon contact with an alkaline solution, in addition to the metal silicon and/or silicon oxide, may also be used to form pores in the negative electrode active material composite particles, if such a component is eluted out in step (c). Aluminum is an example of such a component.

### <Binder>

As shown in FIG. 1, the negative electrode active material layer of the disclosure comprises a particulate binder 20 which binds together the multiple negative electrode active material composite particles. If the binder is particulate, it will be possible to reduce the irreversible capacity of the battery and to thus improve the initial charge-discharge efficiency of the battery. In FIG. 1, the binder 20 is shown as spherical, but the shape of the binder 20 is not limited to this shape.

The binder is not particularly restricted so long as it is particulate, and it may be one that is commonly used in batteries. In particular, the binder may be polyvinylidene fluoride (PVdF). PVdF can react with sodium ion as the carrier ion, for example, but the high bindability of PVdF allows a satisfactory negative electrode active material layer to be formed even when the binder is provided in a particulate form.

The binder content is not particularly restricted, and it may be appropriately set in consideration of the bindability of the binder and the potential size of irreversible capacity that may be generated. The binder content may be 1 mass % to 10 mass %, for example. The content may be 1 mass % or greater, 2 mass % or greater, 3 mass % or greater, 4 mass % or greater or 5 mass % or greater, and 10 mass % or lower, 9 mass % or lower, 8 mass % or lower, 7 mass % or lower, 6 mass % or lower or 5 mass % or lower. This can effectively improve the initial charge-discharge efficiency of the battery.

### <Hard Carbon>

The negative electrode active material layer may further comprise hard carbon. This can effectively improve the initial charge-discharge efficiency of the battery. Hard carbon can function as a negative electrode active material.

### <Other Components>

The negative electrode active material layer may further comprise components other than those mentioned above. Examples of such components include conductive aids. When the battery of the disclosure is a solid-state battery, the negative electrode active material layer may also comprise a solid electrolyte. These components may be ones that are ordinarily used in batteries.

### <Method for Producing Negative Electrode Active Material Layer>

The negative electrode active material layer of the disclosure can be produced by a method comprising the following steps, for example:
providing a mixture slurry comprising negative electrode active material composite particles, a binder and a dispersing medium; and
coating the mixture slurry onto a substrate and drying and removing the dispersing medium.

The negative electrode active material composite particles and binder are as described above.

The dispersing medium is not particularly restricted so long as it can disperse the negative electrode active material composite particles and the binder. When the binder is PVdF, for example, the dispersing medium may be water. In this case, the water used as the dispersing medium may contain carboxymethyl cellulose (CMC) as a thickener. The amount of thickener may be set as appropriate in consideration of the desired viscosity for the dispersing medium.

The method of providing the mixture slurry is not particularly restricted, and an example is a method of mixing each of the starting materials.

For the purpose of the disclosure, “mixture” means a composition that can form an active material layer either by itself or by further comprising other components. Moreover, the term “mixture slurry” means a slurry that comprises a dispersing medium in addition to the “mixture”, allowing it to form an active material layer by being coated and dried.

The substrate is also not particularly restricted and may be a negative electrode collector layer or release sheet, for example.

The method of coating the mixture slurry onto the substrate is not particularly restricted, and it may be appropriately set according to the viscosity of the slurry.

There are no particular restrictions on the method of drying and removing the dispersing medium. The drying conditions, such as the drying temperature and drying time, are not particularly restricted and may be appropriately set in consideration of the amount of dispersing medium used and the boiling point.

### <Battery>

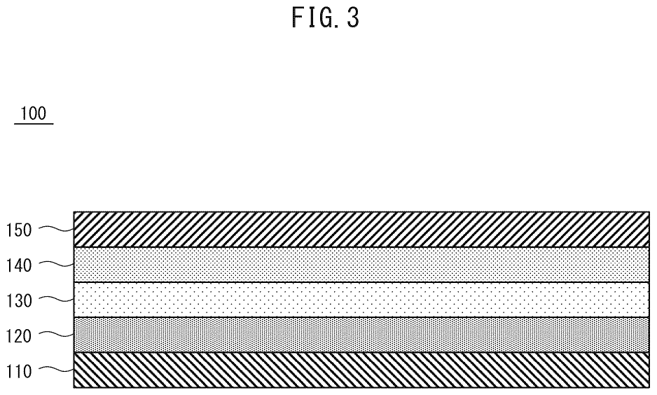

The battery of the disclosure has a negative electrode active material layer of the disclosure. As in the example shown in FIG. 3, the battery 100 of the disclosure may have a negative electrode collector layer 110, a negative electrode active material layer 120 of the disclosure, an electrolyte layer 130, a positive electrode active material layer 140 and a positive electrode collector layer 150.

The battery of the disclosure may be a liquid battery or a solid-state battery, and especially a liquid battery. The term “solid-state battery” as used herein refers to a battery comprising at least a solid electrolyte as the electrolyte, where the solid-state battery may also employ a combination of a solid electrolyte and a liquid electrolyte as the electrolyte. Alternatively, the solid-state battery may be an all-solid-state battery, i.e. a battery comprising only a solid electrolyte as the electrolyte.

The battery of the disclosure may be a primary battery or a secondary battery, and is most especially a secondary battery.

The secondary battery may be a lithium ion secondary battery, for example, or a sodium ion secondary battery, and it is especially a sodium ion secondary battery.

The battery of the disclosure may be constrained by a constraining member such as an end plate, from both sides in the stacking direction of each layer. The constraining method may be, but is not limited to, a method utilizing the constraining torque of a bolt.

The elements composing the battery of the disclosure will now be described.

### <Negative Electrode Collector Layer>

The negative electrode collector layer may be formed of a metal known for use in a negative electrode collector layer for a battery.

### <Negative Electrode Active Material Layer>

The negative electrode active material layer is as described above.

### <Electrolyte Layer>

The electrolyte layer may be one that is known as an electrolyte layer for use in batteries.

When the battery of the disclosure is a liquid battery, the electrolyte layer may be formed by impregnating a separator with an electrolyte solution.

When the battery of the disclosure is a solid-state battery, the solid electrolyte layer can function as the separator. The solid electrolyte layer comprises a solid electrolyte.

### <Positive Electrode Active Material Layer>

The positive electrode active material layer comprises a positive electrode active material, and may also optionally comprise a conductive aid and a binder. When the battery of the disclosure is a solid-state battery, the positive electrode active material layer may also optionally comprise a solid electrolyte.

The positive electrode active material may be one that is publicly known as a positive electrode active material for use in batteries.

The conductive aid, binder and solid electrolyte may be components that are publicly known for use in batteries.

### <Positive Electrode Collector Layer>

The positive electrode collector layer may be formed of a metal that is known for use in a positive electrode collector layer for a battery.

### <Remaining Construction>

The battery may have any of the constructions described above housed inside an exterior body. The exterior body used may be any publicly known type which is used as an exterior body for batteries. A plurality of batteries may also be optionally electrically connected and optionally stacked to form a battery assembly. In this case the assembled batteries may be housed inside a publicly known battery case. The battery may have an obvious type of construction, with the necessary terminals, for example. The form of the battery may be, for example, a coin, laminated (pouch), cylindrical or rectilinear form.

### EXAMPLES

### Example 1

### <Preparation of Negative Electrode Active Material Composite Particles>

A starting material comprising a carbon material, tin, and cobalt as the metal that forms an alloy with tin, was weighed out to a specified compositional ratio. The total mass of the starting materials was 20 g. In a 500 mL chromium steel container there were loaded 400 g of SUS balls and the weighed out starting materials, and after exchange with argon (Ar) gas, they were sealed and treated by mechanical alloying for 44 hours at a rotational speed of 250 rpm. A carbon-tin alloy complex was thus obtained.

After measuring out a specified amount of metal silicon (Si) powder, it was loaded into the container and exchanged with Ar gas, after which it was sealed and treated by mechanical alloying for 1.5 hours at a rotational speed of 250 rpm. After treatment, the material in the container was recovered and classified using a mesh with 53 μm openings, and the mesh-passed powder was recovered. A negative electrode active material composite particle precursor was thus obtained.

The obtained negative electrode active material composite particle precursor was contacted with an alkaline solution to elute out the Si. Specifically, 5 g of the negative electrode active material composite particle precursor was immersed for 4 hours in 250 mL of a 2 M NaOH solution while stirring. It was washed and filtered with 3 L of ion-exchanged water, and then vacuum dried at ordinary temperature. This produced negative electrode active material composite particles with pores.

### <Preparation of Negative Electrode Active Material Layer>

A dispersing medium was obtained by dissolving 2 mass % of carboxymethyl cellulose (CMC) in purified water. The following: negative electrode active material composite particles/acetylene black (AB) as a conductive aid/polyvinylidene fluoride (PVdF) as a binder, was mixed and kneaded with the obtained dispersing medium to obtain a negative electrode mixture slurry. The solid ratio (mass ratio) was: negative electrode active material composite particles/AB/PVdF/CMC=80/12/5/3. The obtained negative electrode mixture slurry was coated onto an aluminum foil as a negative electrode collector layer and pressed, and then vacuum dried for 3 hours at 185° C. to fabricate a negative electrode active material layer. The stack comprising the negative electrode active material layer and negative electrode collector layer obtained in this manner was provided as a test electrode. Since the PVdF did not dissolve in the dispersing medium by this method, the binder in the obtained negative electrode active material layer was particulate.

### <Fabrication of Battery>

A metal sodium foil was used as the counter electrode for the test electrode. The electrolyte solution used was 1 M NaPF₆ in PC/EC. The separator used was polyethylene with a thickness of 15 μm. A coin cell (CR2032) for Example 1 was fabricated in this manner.

### <Evaluation>

### <Initial Charge-Discharge Efficiency>

Evaluation was carried out with a voltage range of 0.005 V-2.0 V and a 0.1 C rate. The initial charge-discharge efficiency was calculated using the capacity during initial Na insertion (charge capacity) as the denominator and the capacity during Na desorption (discharge capacity) as the numerator. The evaluation was carried out in a thermostatic bath at 25° C.

### Example 2

A battery for Example 2 was obtained and evaluated in the same manner as Example 1, except that hard carbon (HC) was further added as the negative electrode active material. The binder in the negative electrode active material layer was particulate.

### Comparative Example 1

In the step of fabricating the negative electrode active material layer, PVdF was dissolved in N-methyl-2-pyrrolidone (NMP), and the negative electrode active material composite particles and AB were mixed and kneaded in the solution to prepare a slurry. The solid ratio (mass ratio) was: negative electrode active material composite particles/AB/PVdF=80/15/5. A battery for Comparative Example 1 was then obtained and evaluated in the same manner as Example 1. Since the PVdF dissolved in NMP by this method, the binder in the negative electrode active material layer was in the form of a film covering the negative electrode active material composite particles.

### Comparative Example 2

A battery for Comparative Example 2 was obtained and evaluated in the same manner as Comparative Example 1, except that the solid ratio (mass ratio) was: negative electrode active material composite particles/AB/PVdF=80/10/10. The binder in the negative electrode active material layer was in the form of a film covering the negative electrode active material composite particles.

The evaluation results for each Example are shown in Table 1.

TABLE 1

| | Additional | | | | Initial |
|---|---|---|---|---|---|
| | negative | | | | charge- |
| | electrode | Binder | | | discharge |
| | active | | Content | Dispersing | efficiency |
| | material | Form | [mass %] | medium | [%] |
| Comp. | — | Film | 5 | NMP | 80 |
| Example 1 | | | | | |
| Comp. | — | Film | 10 | NMP | 79 |
| Example 2 | | | | | |
| Example 1 | — | Particles | 5 | Water + | 84 |
| | | | | CMC | |
| Example 2 | HC | Particles | 5 | Water + | 86 |
| | | | | CMC | |

As shown in Table 1, the initial charge-discharge efficiency was high with the batteries of the Examples.

### REFERENCE SIGNS LIST

10 Negative electrode active material composite particles
11 Carbon material
12 Tin alloy
13 Metal silicon and/or silicon oxide
14 Pore
20 Binder
100 Battery
110 Negative electrode collector layer
120 Negative electrode active material layer
130 Electrolyte layer
140 Positive electrode active material layer
150 Positive electrode collector layer

1. A negative electrode active material layer comprising negative electrode active material composite particles and a particulate binder which binds together the negative electrode active material composite particles,
wherein the negative electrode active material composite particles:
comprise a carbon material and a tin alloy supported in the carbon material, and
have pores.

2. The negative electrode active material layer according to claim 1, wherein the binder is polyvinylidene fluoride.

3. The negative electrode active material layer according to claim 1, wherein the binder content is 1 mass % to 10 mass %.

4. The negative electrode active material layer according to claim 1, which further comprises hard carbon.

5. A battery having a negative electrode active material layer according to claim 1.
